(19) United States
(12) Patent Application Publication
(10) Pub. No.: US 2025/0013676 A1
(43) Pub. Date: Jan. 9, 2025

(54) METHOD FOR INFORMATION PROCESSING BASED ON LARGE LANGUAGE MODEL

(71) Applicant: BEIJING BAIDU NETCOM SCIENCE TECHNOLOGY CO., LTD., BEIJING (CN)

(72) Inventors: Jinchang LUO, BEIJING (CN); Bolei HE, BEIJING (CN); Kunbin CHEN, BEIJING (CN); Wei HE, BEIJING (CN)

(73) Assignee: BEIJING BAIDU NETCOM SCIENCE TECHNOLOGY CO., LTD., BEIJING (CN)

(21) Appl. No.: 18/889,497

(22) Filed: Sep. 19, 2024

(30) Foreign Application Priority Data
Jun. 20, 2024 (CN) 202410804781.3

(51) Int. Cl. G06F 16/332; G06F 16/33

(52) U.S. Cl. CPC G06F 16/3329; G06F 16/334

(57) ABSTRACT

A computer-implemented method for information processing based on a large language model is provided. The method includes obtaining query information provided by a user. The method further includes determining memory information related to the query information. The method further includes determining, based on the query information and the memory information, a tool for processing the query information. The method further includes invoking the tool to obtain auxiliary information. The method further includes generating, based on the query information and the auxiliary information, a result of processing the query information.

### CROSS REFERENCE TO RELATED APPLICATION

This application claims priority to Chinese Patent Application No. 202410804781.3 filed on Jun. 20, 2024, the contents of which are hereby incorporated by reference in their entirety for all purposes.

### TECHNICAL FIELD

The present disclosure relates to the technical field of artificial intelligence, and in particular, to the fields of large language models (LLMs), artificial intelligence agents, and the like. Specifically, the present disclosure relates to an information processing method and apparatus based on a large language model, an electronic device, a computer-readable storage medium, a computer program product, and an intelligent assistant based on a large language model.

### BACKGROUND ART

Artificial intelligence is a subject on making a computer simulate some thinking processes and intelligent behaviors (such as learning, reasoning, thinking, and planning) of a human, and involves both hardware-level technologies and software-level technologies. Artificial intelligence hardware technologies generally include the technologies such as sensors, dedicated artificial intelligence chips, cloud computing, distributed storage, and big data processing. Artificial intelligence software technologies mainly include the following several general directions: computer vision technologies, speech recognition technologies, natural language processing technologies, machine learning/deep learning, big data processing technologies, and knowledge graph technologies.

In recent years, large language models have continued to attract attentions from the industry for their powerful understanding and reasoning capabilities and their wide range of uses. Artificial intelligence agents that have emerged based on the large language models have also become the main applications for assisting the implementation of the large language model in practice.

Methods described in this section are not necessarily methods that have been previously conceived or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY

The present disclosure provides an information processing method and apparatus based on a large language model, an electronic device, a computer-readable storage medium, a computer program product, and an intelligent assistant based on a large language model.

According to an aspect of the present disclosure, it is provided an information processing method based on a large language model. The method includes obtaining query information provided by a user; determining memory information related to the query information; determining, based on the query information and the memory information, a tool for processing the query information; invoking the tool to obtain auxiliary information; and generating, based on the query information and the auxiliary information, a result of processing the query information.

According to another aspect of the present disclosure, it is provided an electronic device, including at least one processor; and a memory communicatively connected to the at least one processor, where the memory stores instructions executable by the at least one processor, and the instructions, when executed by the at least one processor, cause the at least one processor to perform the method described above.

According to another aspect of the present disclosure, it is provided a non-transitory computer-readable storage medium storing computer instructions, where the computer instructions are used to cause a computer to perform the method described above.

It should be understood that the content described in this section is not intended to identify critical or important features of the embodiments of the present disclosure, and is not used to limit the scope of the present disclosure. Other features of the present disclosure will be readily understood with reference to the following description.

### BRIEF DESCRIPTION OF THE DRAWINGS

The accompanying drawings show exemplary embodiments and form a part of the specification, and are used to explain exemplary implementations of the embodiments together with a written description of the specification. The embodiments shown are merely for illustrative purposes and do not limit the scope of the claims. Throughout the accompanying drawings, the same reference numerals denote similar but not necessarily same elements.

FIG. 1 is a schematic diagram of an example system in which various methods described herein can be implemented according to embodiments of the present disclosure;

FIG. 2 is a flowchart of an information processing method based on a large language model according to an embodiment of the present disclosure;

FIG. 3 is a schematic diagram of invoking a clarification tool to interact with a user according to an embodiment of the present disclosure;

FIG. 4 is a schematic diagram of a retrieval tool according to an embodiment of the present disclosure;

FIG. 5 is a flowchart of a process of reflecting on tool invoking according to an embodiment of the present disclosure;

FIG. 6 is a flowchart of an operation of an intelligent assistant according to an embodiment of the present disclosure;

FIG. 7 is a block diagram of a structure of an information processing apparatus based on a large language model according to an embodiment of the present disclosure;

FIG. 8 is a block diagram of a structure of an information processing apparatus based on a large language model according to another embodiment of the present disclosure; and

FIG. 9 is a block diagram of a structure of an example electronic device that can be used to implement an embodiment of the present disclosure.

### DETAILED DESCRIPTION

Exemplary embodiments of the present disclosure are described below in conjunction with the accompanying drawings, where various details of the embodiments of the present disclosure are included to facilitate understanding, and should only be considered as exemplary. Therefore, those of ordinary skill in the art should be aware that various changes and modifications can be made to the embodiments described here, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one element from the other. In some examples, a first element and a second element may refer to a same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed terms.

In the related art, a conventional intelligent assistant is generally implemented through frequently asked questions (FAQ) matching or graph question answering. Whether it is FAQ matching or graph question answering, it requires a lot of manpower to pre-build a FAQ database or a graph. Even so, it is difficult to cover a full range of questions. Besides, the data updating, maintenance, and the like also have high technical and manpower costs. In addition, it is not easy for FAQ matching or graph question answering to provide a good experience for a user, because answers are all the same for the same or similar queries, and thus an intelligence degree is insufficient. In recent years, with the development of large language models and artificial intelligence agents, the industry has gradually conceived developing of more application scenarios based on large language model-based artificial intelligence agents that can be applied to actual production and life. As one of these application scenarios, implementation of an intelligent assistant on a large language model has received widespread attention. How to develop more application scenarios based on large language model-based artificial intelligence agents that can be applied to actual production and life is still one of the hot topics in industry research.

In view of this, an embodiment of the present disclosure provides an information processing method that can be used to effectively construct an intelligent assistant that is based on a large language model.

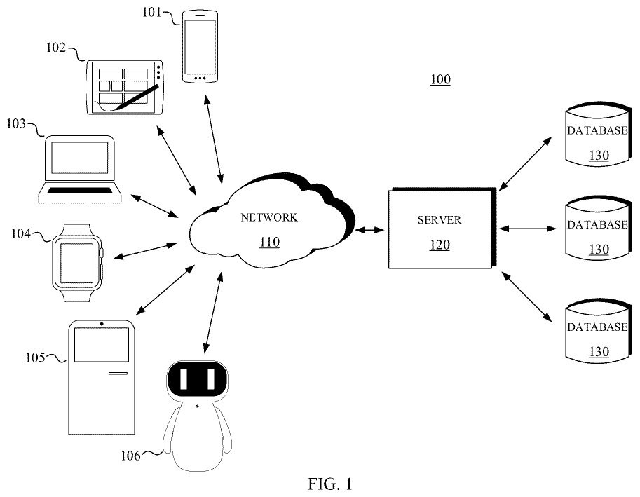

Before the method in the embodiments of the present disclosure is described in detail, an example system in which the method described herein may be implemented is described with reference to FIG. 1.

FIG. 1 is a schematic diagram of an example system 100 in which various methods and apparatuses described herein can be implemented according to an embodiment of the present disclosure. Referring to FIG. 1, the system 100 includes one or more client devices 101, 102, 103, 104, 105, and 106, a server 120, and one or more communications networks 110 that couple the one or more client devices to the server 120. The client devices 101, 102, 103, 104, 105, and 106 may be configured to execute one or more applications.

In an embodiment of the present disclosure, the server 120 can run one or more services or software applications that enable an information processing method to be performed.

In some embodiments, the server 120 may further provide other services or software applications that may include a non-virtual environment and a virtual environment. In some embodiments, these services may be provided as web-based services or cloud services, for example, provided to a user of the client devices 101, 102, 103, 104, 105, and/or 106 in a software as a service (SaaS) model.

In the configuration shown in FIG. 1, the server 120 may include one or more components that implement functions performed by the server 120. These components may include software components, hardware components, or a combination thereof that can be executed by one or more processors. A user operating the client devices 101, 102, 103, 104, 105, and/or 106 may sequentially use one or more client applications to interact with the server 120, to use the services provided by these components. It should be understood that various different system configurations are possible, and may be different from that of the system 100. Therefore, FIG. 1 is an example of the system for implementing various methods described herein, and is not intended to be limiting.

The user may interact with the intelligent assistant by using the client devices 101, 102, 103, 104, 105, and/or 106. The client device may provide an interface that enables the user of the client device to interact with the client device. The client device may also output information to the user via the interface. Although FIG. 1 shows only six client devices, those skilled in the art will understand that any number of client devices are supported in the present disclosure.

The client devices 101, 102, 103, 104, 105, and/or 106 may include various types of computer devices, such as a portable handheld device, a general-purpose computer (such as a personal computer and a laptop computer), a workstation computer, a wearable device, a smart screen device, a self-service terminal device, a service robot, a gaming system, a thin client, various messaging devices, and a sensor or other sensing devices. These computer devices can run various types and versions of software applications and operating systems, such as MICROSOFT Windows, APPLE IOS, a UNIX-like operating system, and a Linux or Linux-like operating system (e.g., GOOGLE Chrome OS); or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various applications, such as various Internet-related applications, communication applications (e.g., email applications), and short message service (SMS) applications, and can use various communication protocols.

The network 110 may be any type of network well known to those skilled in the art, and may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a blockchain network, a public switched telephone network (PSTN), an infrared network, a wireless network (such as Bluetooth or WIFI), and/or any combination of these and/or other networks.

The server 120 may include one or more general-purpose computers, a dedicated server computer (for example, a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures related to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any of the above operating systems and any commercially available server operating system. The server 120 can also run any one of various additional server applications and/or middle-tier applications, including an HTTP server, an FTP server, a CGI server, a JAVA server, a database server, etc.

In some implementations, the server 120 may include one or more applications to analyze and merge data feeds and/or event updates received from users of the client devices 101, 102, 103, 104, 105, and/or 106. The server 120 may further include one or more applications to display the data feeds and/or real-time events via one or more display devices of the client devices 101, 102, 103, 104, 105, and/or 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be configured to store information such as an audio file and a video file. The databases 130 may reside in various locations. For example, a database used by the server 120 may be locally in the server 120, or may be remote from the server 120 and may communicate with the server 120 via a network-based or dedicated connection. The database 130 may be of different types. In some embodiments, the database used by the server 120 may be, for example, a relational database. One or more of these databases can store, update, and retrieve data from or to the database, in response to a command.

In some embodiments, one or more of the databases 130 may also be used by an application to store application data. The database used by the application may be of different types, for example, may be a key-value repository, an object repository, or a regular repository backed by a file system.

The system 100 of FIG. 1 may be configured and operated in various manners, such that various methods described according to the present disclosure can be applied.

The following describes in detail aspects of an information processing method based on a large language model and an intelligent assistant according to the embodiments of the present disclosure with reference to the accompanying drawings.

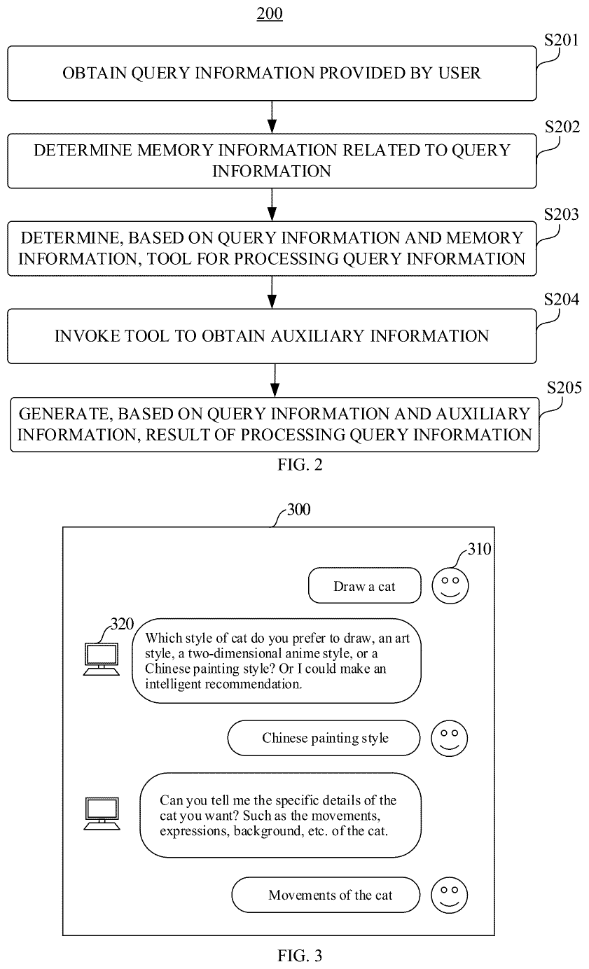

FIG. 2 is a flowchart of an information processing method 200 based on a large language model according to an embodiment of the present disclosure.

In this embodiment of the present disclosure, the information processing method 200 may be implemented by an intelligent assistant that is based on an artificial intelligence agent. The intelligent assistant may be, for example, a knowledge assistant such as a newcomer assistant, a sales assistant, a travel assistant, or a news information assistant. The artificial intelligence agent may invoke a large language model to perform the information processing method 200, thereby implementing the functions of the intelligent assistant.

As shown in FIG. 2, the method 200 includes steps S201, S202, S203, S204, and S205.

In step S201, query information provided by a user is obtained.

In an example, the user may obtain, by providing query information for a specific question or a need to the intelligent assistant, an answer to the question or a response to the need from the intelligent assistant. For example, in the application scenario of the newcomer assistant, the user may ask a question such as “What is the corporate culture of the company”; in the application scenario of the sales assistant, the user may ask a question such as “How to clean the product”; in the application scenario of the travel assistant, the user may ask a question such as “How to travel three days in Shanghai”; and in the application scenario of the news information assistant, the user may ask a question such as “What is the trend of autonomous driving technologies”. That is, the query information provided by the user may include a question that the user intends to be answered or an instruction that is used by the user to meet a need.

In an example, after obtaining the query information provided by the user, the intelligent assistant may invoke a large language model to understand the query information of the user. This can depend on the powerful understanding capability provided by the large language model.

In an example, the intelligent assistant may provide an interface for interacting with a user, so that the user may send query information to the intelligent assistant in a form such as text or speech on the interface, and the intelligent assistant may also provide, on the interface, feedback on the query information provided by the user.

In step S202, memory information related to the query information is determined.

In an example, the memory information may reflect whether the user has interacted with the intelligent assistant on a topic related to the query information. For example, in the application scenario of the travel assistant, the user may instruct the intelligent assistant to help him/her select several target travel cities. In this case, the intelligent assistant may first determine whether the user has previously mentioned his or her preferred city, preferred travel mode, etc. By determining this memory information, it is beneficial to maintain consistency and coherence in the content of interaction between the user and the intelligent assistant, thereby facilitating the user to feel the intelligence of the interaction.

In an example, if the query information provided by the user is related to a new topic and a content related to the topic has never been involved in an interaction with the intelligent assistant, the memory information may also be empty.

In step S203, a tool for processing the query information is determined based on the query information and the memory information.

In an example, processing the query information may include answering a question contained in the query information. In this case, the corresponding tool may include a tool for performing retrieval (such as a news search tool), through which information required to answer a question contained in the query information can be obtained. Processing the query information may also include responding to an instruction contained in the query information. In this case, the corresponding tool may include a tool for performing a specific function (such as a painting tool). The tool may be in a form of a plug-in, for example.

In an example, since the intelligent assistant is constructed based on an artificial intelligence agent, this enables the intelligent assistant to have tool determination and invoking capabilities of the artificial intelligence agent. In this embodiment of the present disclosure, when determining a tool, the memory information is taken into consideration in addition to the query information, so that the decision of determining the tool can be more accurate and comprehensive, thereby facilitating the implementation of intelligent interaction.

In step S204, the tool is invoked to obtain the auxiliary information.

In an example, the auxiliary information may include data returned after the tool is invoked. The step of invoking the tool also benefits from the tool invoking capability of the artificial intelligence agent. For example, in the application scenario of the news information assistant, the user may ask the intelligent assistant about the hot news of the past two days. The intelligent assistant may invoke, for example, a news search tool, to search for the news on the Internet and aggregate the news to the user. Therefore, the auxiliary information can include the found news items. That is, the auxiliary information may refer to information needed to assist the underlying large language model in processing of the query information. The auxiliary information may be used as an intermediate reference to assist the large language model in reasoning and summarizing.

In step S205, a result of processing the query information is generated based on the query information and the auxiliary information.

In an example, the intelligent assistant may invoke the large language model to perform reasoning and summarizing with both the query information and the auxiliary information, so as to provide feedback to the user on the query information. Depending on the content of the query information, such as a specific question or instruction, the result of processing the query information may include, for example, an answer provided to the user or a result after execution of the instruction.

Therefore, according to the information processing method 200 in this embodiment of the present disclosure, an information processing method for effectively constructing an intelligent assistant is provided, where the memory information related to the query information is further obtained on the basis of obtaining the query information provided by the user, so that a tool required for processing the query information may be accurately determined based on the query information and the memory information. Therefore, on this basis, the auxiliary information required for generating a processing result is obtained by invoking the tool, thereby facilitating the accurate generation, based on the query information and the auxiliary information, of the result of processing the query information. The overall operating logic of the information processing method is conducive to intelligent implementation of the interaction function of the intelligent assistant, improving the user experience of using the intelligent assistant.

In some embodiments, the memory information may be obtained based on a dialogue content retrieved from a historical dialogue of the user that matches the query information.

In an example, the user may have interacted with the intelligent assistant, that is, there may have been at least one round of historical dialogue. In this case, the dialogue content that matches the query information may be retrieved from the historical dialogue as memory information, while the dialogue content that does not match the query information may be filtered out.

In an example, retrieval of the memory information in the historical dialogue may be implemented through an Elasticsearch (ES) retrieval engine or a semantic retriever.

Thus, by determining the memory information from the historical dialogue of an interaction with the user, a historical record related to the query information may be obtained directly and simply from easily accessible data sources. Meanwhile, because the historical dialogue may also reflect personalized content such as user preferences, the intelligent interaction can be facilitated, thereby improving the user experience of using the intelligent assistant.

In some embodiments, the tool in step S203 as shown in FIG. 2 may include a clarification tool, and the invoking of the tool to obtain the auxiliary information in step S204 may include: invoking the clarification tool to initiate an interaction with the user; and obtaining, through the interaction, interpretation information by the user for the query information.

In an example, when the user enters the query information to the intelligent assistant, but the intelligent assistant may not determine a tool to be used based on the query information, for example, there may be a plurality of optional tools that can be invoked, the intelligent assistant may first invoke the clarification tool to actively initiate an interaction with the user, thereby obtaining, from further interpretation by the user, more information that is helpful to the determination. That is, the interpretation information provided by the user may include information that further reflect an intention of the user on the basis of the query information.

Therefore, a mechanism for active interaction with the user is provided by providing a clarification tool, so that the intelligent assistant can use the process of active interaction to accurately confirm an intention of the user, and then provide corresponding feedback to the user based on the intention of the user. This significantly increases the intelligence degree of the intelligent assistant, thereby facilitating to provide users with solutions to personalized problems or needs.

In some embodiments, the invoking of the clarification tool to initiate an interaction with the user may include: querying the user to guide the user to provide the interpretation information.

In an example, the tool may be in a form of a plug-in that has its corresponding parameter such that the plug-in can be invoked when an entered parameter matches the parameter. Therefore, querying the user may include guiding the user to answer a question and obtain clarification of the parameter of the plug-in. In addition, when the query information provided by the user is too brief, optional targets may be listed through a query to the user, thereby guiding the user to clearly confirm an intention of the user, that is, to clarify the objective.

Thus, guiding the user to provide interpretation information through a query can not only be helpful to accurately confirm the intention of the user, but also can provide friendliness and personalization for the interaction process. This allows the user to experience intelligence naturally during this interaction process, thus adding good experience.

FIG. 3 is a schematic diagram of invoking a clarification tool to interact with a user according to an embodiment of the present disclosure.

FIG. 3 shows an example process of a user 310 interacting with an intelligent assistant 320 on an interaction interface 300. The user 310 sends query information “Draw a cat”, and the intelligent assistant 320 may find, when determining a tool after receiving the query information, that plug-ins for drawing a cat includes a plug-in for drawing an art-style cat, a plug-in for drawing a cat in a two-dimensional anime-style, and a plug-in for drawing a cat in a Chinese painting style. Therefore, a clarification tool may be invoked first to guide the user to confirm which style of cat the user wants to draw, and then an actively initiate an interaction with the user by asking “Which style of cat do you prefer to draw, an art style, a two-dimensional anime style, or a Chinese painting style? Or I could make an intelligent recommendation” is performed. The user 310 then gives further interpretation information under the guidance of the query, that is, the user answers “Chinese painting style”.

However, because the query information sent by the user includes only the intention to draw a cat, without clearly indicating a specific content about the cat, the intelligent assistant 320 can actively initiate an active interaction with the user again by asking “Can you tell me the specific details of the cat you want? Such as the movements, expressions, background, etc. of the cat”. The user 310 then gives still further interpretation information under the guidance of the query, that is, the user answers “Movements of the cat”.

As such, the intelligent assistant 320 accurately determines, by invoking the clarification tool, that the user 310 intends to obtain a painting about the movements of the cat in the Chinese painting style, and on this basis, a corresponding painting plug-in to perform the task may be correctly invoked.

It can be understood that FIG. 3 is described by using an example in which the query information is an instruction that is used by the user to meet a need, however, the scope of the present disclosure is not limited thereto, and the query information may alternatively be a question to which the user intends to be answered.

In some embodiments, the tool in step S203 as shown in FIG. 2 may include a retrieval tool, and the invoking of the tool to obtain the auxiliary information in step S204 may include: invoking the retrieval tool to retrieve data resources to obtain reference information for answering the query information.

In an example, when the intelligent assistant is a knowledge assistant such as a newcomer assistant, a sales assistant, a travel assistant, or a news information assistant, the user usually wants to implement functions such as knowledge answering, news information query, information recommendation, etc. by using the intelligent assistant. In view of this, a retrieval tool may be designed to acquire reference information required for giving an answer to a question of the user.

Therefore, the accuracy of understanding and reasoning in the underlying large language model may be facilitated by invoking a retrieval tool to obtain useful reference information, thereby increasing the intelligence degree and reliability of the intelligent assistant.

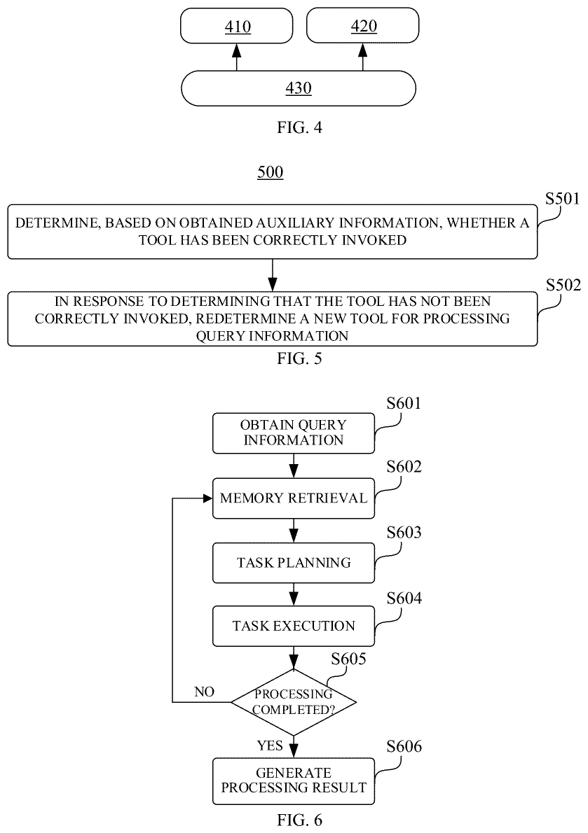

FIG. 4 is a schematic diagram of a retrieval tool according to an embodiment of the present disclosure.

As shown in FIG. 4, the retrieval tool may include a first retriever 410, a second retriever 420, and a retrieval agent 430. The first retriever 410 may be a document retriever, which may be configured to retrieve multimodal data such as text data, image data, structured data (such as tables), etc. The second retriever 420 may be a universal retriever, which may be configured to crawl a web page to obtain news information data such as news or trends. The retrieval agent 430 may be pre-constructed, which may first transform a retrieval element including a keyword and/or semantics, and then invoke the first retriever 410 and the second retriever 420 to complete the retrieval.

In some embodiments, the first retriever 410 may be invoked to retrieve business data including a plurality of business documents to obtain at least one target business document associated with the query information, where the at least one target business document is ranked according to a predetermined ranking strategy.

In an example, the business data may be provided by a customizer of the intelligent assistant and prebuilt in the intelligent assistant. For example, when the intelligent assistant is a sales assistant, the business data may include data provided by a seller that are related to the sale product, such as plans, cases, leads, and pictures. The data may be in a form of a business document for easy retrieval.

In an example, the retrieved at least one target business document may be obtained through two processes: recall and ranking. In the recall process, all of business documents related to the query information can be recalled using the ES retrieval engine or semantic retriever to ensure the comprehensiveness of the retrieval. In the ranking process, the ranking may be performed using another small or lightweight large language model. To this end, by means of providing a prompt to instruct such large language model how to rank, the business documents retrieved during the recall process may be ranked according to a predetermined ranking strategy to finally obtain the required at least one target business document. The predetermined ranking strategy may be related to relevance, document quality, and/or timeliness. For example, the target business documents may be the top 10 business documents of 100 recalled business documents ranked by relevance in a descending order.

Thus, the first retriever 410 that supports multimodal data retrieval may be invoked to perform comprehensive retrieval on the business data in a document form, so as to maximize the acquisition of reference information for answering the query information. In addition, because the retrieval strategy includes both recall and ranking, it can not only ensure the comprehensiveness of the retrieval, but also achieve the accuracy of the retrieval by setting the ranking strategy according to a specific retrieval need. This facilitates the accuracy and intelligence of the intelligent assistant in giving answers.

In some embodiments, the second retriever 420 may be invoked to retrieve news information data including a plurality of news information entries to obtain at least one target news information entry associated with the query information.

In an example, the news information data may include news or trends from the Internet, etc. The news information data may be accessed through a preset interface, such as the news.baidu.com API (Application Programming Interface). For example, when the intelligent assistant is a news information assistant, the user may query the intelligent assistant for news information of interest in the form of query information. Thus, the intelligent assistant may invoke the second retriever 420 to acquire the retrieved target news information entry.

In an example, the target news information entry may also be obtained through the recall and ranking processes as described above.

Therefore, by means of invoking the second retriever 420 that may be used to crawl a web page to obtain news information data such as news or trends, it helps to ensure that web-wide news information is retrieved comprehensively and in real time, and then helps to acquire reference information for answering the query information. This facilitates the accuracy and intelligence of the intelligent assistant in giving answers.

In some embodiments, the retrieval of the first retriever 410 or the second retriever 420 may be based on the transformed retrieval element. The retrieval element may include a keyword and/or semantics corresponding to the query information.

In an example, the retrieval agent 430 may be pre-constructed and invoked. As described above, the retrieval agent 430 may first transform a retrieval element including a keyword and/or semantics, and then invoke the first retriever 410 and the second retriever 420 to complete the retrieval. That is, the retrieval of the first retriever 410 or the second retriever 410 may be based on the transformed retrieval element.

In an example, the purpose of transforming the retrieval element is to expand and extend a retrieval direction to help the intelligent assistant deal with more complex or open query information from the user. For example, the user may intend to learn about the evolution of autonomous driving technologies. To this end, the intelligent assistant may invoke the retrieval agent 430 to deal with the relatively complex question. That is, it may first transform keywords=“autonomous driving” into three new keywords such as: keywords1=“autonomous driving, progress”, keywords2=“autonomous driving, application”, keywords3=“autonomous driving, product”. Then, for example, the second retriever 420 may be invoked to retrieve relevant news information about autonomous driving all over the network. Finally, the retrieved news information entries are ranked based on a specific ranking strategy using another small or lightweight large language model to obtain target news information entries for summarizing and outputting results.

Therefore, through retrieval based on the transforming of the retrieval element, the retrieval ideas may be enhanced, thereby facilitating the screening of valid information that can help to deal with a more complex question, so as to increase the intelligence degree of answering of the intelligent assistant.

In some embodiments, the information processing method 200 as shown in FIG. 2 may further include a process of reflecting on tool invoking.

FIG. 5 is a flowchart of a process 500 of reflecting on tool invoking according to an embodiment of the present disclosure.

As shown in FIG. 5, the process 500 of reflecting on tool invoking may include the following steps. Step S501: determine, based on the obtained auxiliary information, whether the tool has been correctly invoked. Step S502: in response to determining that the tool has not been correctly invoked, redetermine a new tool for processing the query information.

In an example, step S501 may be performed after performing step S204 as shown in FIG. 2 in which the tool is invoked to obtain the auxiliary information. If a result of the determination in step S501 is that the tool has not been correctly invoked, step S502 may be performed, that is, the flow of the information processing method 200 as shown in FIG. 2 may return to step S203 to redetermine the new tool for processing the query information.

Therefore, through adding of a reflection function after the tool invoking, the intelligent assistant may be given the ability to think autonomously so as to analyze errors and correct errors actively. This helps to greatly increase the intelligence degree of the intelligent assistant. In some embodiments, the information processing method 200 as shown in FIG. 2 may further include storing, in a predetermined amount of memory for a current dialogue, the memory information related to the query information and the auxiliary information obtained from the invoking of the tool.

In an example, the predetermined amount of memory may be maintained for the current dialogue. For example, a length of memory may have a predetermined threshold. In view of this, at least the latest task execution result may be retained in the memory so that the length of the memory does not exceed the predetermined threshold. For example, the relatively older task execution results may be discarded using a first-in-first-out mechanism.

Therefore, a historical record unrelated to the current query information may not be retained in the memory used for the current dialogue. In addition, the latest task execution result may be dynamically retained, thereby ensuring the memory is not overloaded.

In some embodiments, the information processing method 200 as shown in FIG. 2 is performed based on a large language model trained by supervised fine-tuning.

In an example, supervised fine-tuning (SFT) training may be performed on a small or lightweight large language model to improve training efficiency and effect.

In an example, the quality of a data set may be improved by data acquisition and/or data cleaning. The data acquisition may be from at least one of the following: generation of training sets through a more powerful large language model, open source data sets, and acquisition of bad example sets from the product through user feedback. The data cleaning may include scoring samples through a plurality of large language models with more powerful capabilities to select samples with scores exceeding a threshold, thereby increasing sample confidence.

In an example, automated evaluation and/or manual evaluation may be used. In the automated evaluation, the generated answers may be scored by a plurality of large language models with more powerful capabilities, and then the average is calculated to evaluate the model effect in an automated manner. In the manual evaluation, the model effect may be evaluated by manual sampling.

Therefore, training a large language model by supervised fine-tuning can improve the efficiency and effect of training, so that the trained large language model can be more effective in the application scenario of the intelligent assistant.

An embodiment of the present disclosure further provides an intelligent assistant based on a large language model. The intelligent assistant performs the method according to the method as described above.

In an example, the information processing method 200 as shown in FIG. 2 may be implemented by an intelligent assistant that is based on an artificial intelligence agent. The artificial intelligence agent may invoke a large language model to perform the information processing method 200, thereby implementing the functions of the intelligent assistant.

FIG. 6 is a flowchart of an operation of an intelligent assistant according to an embodiment of the present disclosure.

As shown in FIG. 6, in step S601, the intelligent assistant may obtain query information provided by a user. The intelligent assistant may invoke a large language model to understand the query information. By invoking the large language model, the intelligent assistant may perform memory retrieval in step S602, that is, determine memory information related to the query information, and may perform task planning in step S603, that is, determine, based on the query information and the memory information, a tool for processing the query information. The intelligent assistant may perform task execution in step S604, that is, invoke the tool determined in step S603 to obtain auxiliary information. The intelligent assistant may continue to determine, in step S605, whether the processing of the query information has been currently completed, and if a result of the determination is “No”, the process returns to the memory retrieval in step S602, and step S603 and S604 are performed again. If a result of the determination is “Yes”, the intelligent assistant may invoke the large language model to draw a conclusion in step S606, that is, generate, based on the query information and the auxiliary information, a result of processing the query information.

An embodiment of the present disclosure further provides an information processing apparatus based on a large language model.

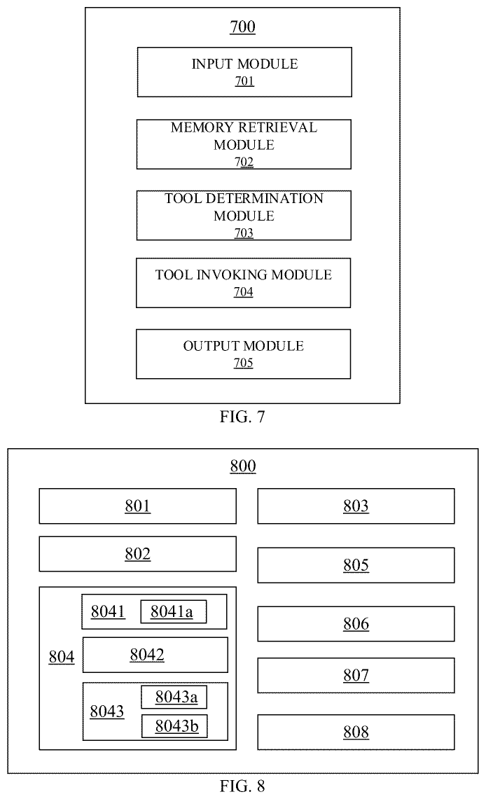

FIG. 7 is a block diagram of a structure of an information processing apparatus 700 based on a large language model according to an embodiment of the present disclosure.

As shown in FIG. 7, the apparatus 700 includes an input module 701, a memory retrieval module 702, a tool determination module 703, a tool invoking module 704, and an output module 705. The input module 701 is configured to obtain query information provided by a user. The memory retrieval module 702 is configured to determine memory information related to the query information. The tool determination module 703 is configured to determine, based on the query information and the memory information, a tool for processing the query information. The tool invoking module 704 is configured to invoke the tool to obtain auxiliary information. The output module 705 is configured to generate, based on the query information and the auxiliary information, a result of processing the query information.

Operations of the input module 701, the memory retrieval module 702, the tool determination module 703, the tool invoking module 704, and the output module 705 may respectively correspond to step S201, S202, S203, S204, and S205 as shown in FIG. 2. Therefore, details of aspects of the operations are omitted herein.

FIG. 8 is a block diagram of a structure of an information processing apparatus 800 based on a large language model according to another embodiment of the present disclosure.

As shown in FIG. 8, the apparatus 800 may include an input module 801, a memory retrieval module 802, a tool determination module 803, a tool invoking module 804, and an output module 805. Operations of the foregoing modules may be the same as those of the input module 701, the memory retrieval module 702, the tool determination module 703, the tool invoking module 704, and the output module 705 as shown in FIG. 7. In addition, the modules described above may include further sub-modules.

In some embodiments, the memory information may be obtained based on a dialogue content retrieved from a historical dialogue of the user that matches the query information.

In some embodiments, the tool may include a clarification tool, and the tool invoking module 804 may include: an interaction initiation module 8041 configured to invoke the clarification tool to initiate an interaction with the user; and a clarification obtaining module 8042 configured to obtain, through the interaction, interpretation information by the user for the query information.

In some embodiments, the interaction initiation module 8041 may include a query module 8041a configured to query the user to guide the user to provide the interpretation information.

In some embodiments, the tool may include a retrieval tool, and the tool invoking module 804 may include an information retrieval module 8043 configured to invoke the retrieval tool to retrieve data resources to obtain reference information for answering the query information.

In some embodiments, the information retrieval module 8043 may include a document retrieval module 8043a configured to invoke a first retriever to retrieve business data including a plurality of business documents to obtain at least one target business document associated with the query information, where the first retriever supports multimodal data retrieval, and the at least one target business document is ranked according to a predetermined ranking strategy.

In some embodiments, the information retrieval module 8043 may include a news information retrieval module 8043b configured to invoke a second retriever to retrieve news information data including a plurality of news information entries to obtain at least one target news information entry associated with the query information.

In some embodiments, the retrieval is performed based on a transformed retrieval element, where the retrieval element includes a keyword and/or semantics corresponding to the query information.

In some embodiments, the apparatus 800 may further include an invoking reflection module 806 configured to determine, based on the obtained auxiliary information, whether the tool has been correctly invoked; and an invoking determination module 807 configured to, in response to determining that the tool has not been correctly invoked, instruct the tool determination module 803 to redetermine a new tool for processing the query information.

In some embodiments, the apparatus 800 may further include an information storage module 808 configured to store, in a predetermined amount of memory for a current dialogue, the memory information related to the query information and the auxiliary information obtained from the invoking of the tool.

In some embodiments, the apparatus 800 may be implemented based on a large language model trained by supervised fine-tuning.

According to an embodiment of the present disclosure, an electronic device is further provided, including at least one processor; and a memory communicatively connected to the at least one processor, where the memory stores instructions executable by the at least one processor, and the instructions, when executed by the at least one processor, cause the at least one processor to perform the method described above.

According to an embodiment of the present disclosure, a non-transitory computer-readable storage medium storing computer instructions is further provided, where the computer instructions are used to cause a computer to perform the method described above.

According to an embodiment of the present disclosure, a computer program product is further provided, including a computer program, where the method described above is implemented when the computer program is executed by a processor.

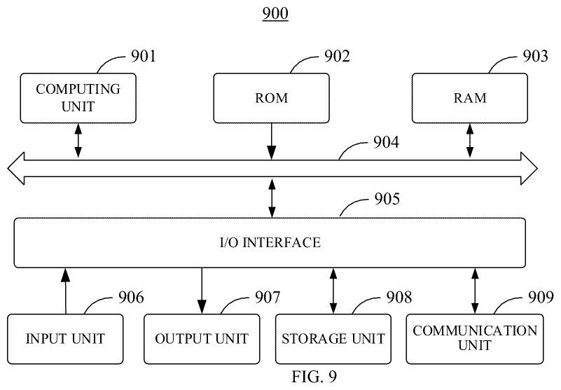

Referring to FIG. 9, a block diagram of a structure of an electronic device 900 that can serve as a server or a client of the present disclosure is now described. The electronic device is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in the present specification, their connections and relationships, and their functions are merely examples, and are not intended to limit the implementation of the present disclosure described and/or required herein.

As shown in FIG. 9, the electronic device 900 includes a computing unit 901. The computing unit may perform various appropriate actions and processing according to a computer program stored in a read-only memory (ROM) 902 or a computer program loaded from a storage unit 908 to a random access memory (RAM) 903. The RAM 903 may further store various programs and data required for the operation of the electronic device 900. The computing unit 901, the ROM 902, and the RAM 903 are connected to each other through a bus 904. An input/output (I/O) interface 905 is also connected to the bus 904.

A plurality of components in the electronic device 900 are connected to the I/O interface 905, including: an input unit 906, an output unit 907, the storage unit 908, and a communication unit 909. The input unit 906 may be any type of device capable of entering information to the electronic device 900. The input unit 906 may receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 907 may be any type of device capable of presenting information, and may include, but is not limited to, a display, a speaker, a video/audio output terminal, a vibrator, and/or a printer. The storage unit 908 may include, but is not limited to, a magnetic disk and an optical disk. The communication unit 909 allows the electronic device 900 to exchange information/data with other devices via a computer network such as the Internet and/or various telecommunications networks, and may include, but is not limited to, a modem, a network interface card, an infrared communications device, a wireless communications transceiver, and/or a chipset, for example, a Bluetooth device, an 802.11 device, a Wi-Fi device, a WiMax device, or a cellular communication device.

The computing unit 901 may be various general-purpose and/or special-purpose processing components with processing and computing capabilities. Some examples of the computing unit 901 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 901 executes the methods and processing described above. For example, in some embodiments, the method may be implemented as a computer software program, and may be tangibly included in a machine-readable medium, for example, the storage unit 908. In some embodiments, a part or all of the computer program may be loaded and/or installed onto the electronic device 900 via the ROM 902 and/or the communication unit 909. When the computer program is loaded to the RAM 903 and executed by the computing unit 901, one or more steps of the method described above may be performed. Alternatively, in another embodiment, the computing unit 901 may be configured in any other proper manner (for example, by using firmware) to execute the method described above.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: implementation in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide an interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other categories of apparatuses can also be used to provide an interaction with the user; for example, feedback provided to the user can be any form of sensory feedback (for example, visual feedback, auditory feedback, or tactile feedback); and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communication network) in any form or medium. Examples of the communication network include: a local area network (LAN), a wide area network (WAN), the Internet, and a blockchain network.

A computer system may include a client and a server. The client and the server are generally far away from each other and usually interact through a communication network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

In the technical solutions of the present disclosure, collection, storage, use, processing, transmission, provision, disclosure, etc. of user personal information involved all comply with related laws and regulations and are not against the public order and good morals.

Although the embodiments or examples of the present disclosure have been described with reference to the accompanying drawings, it should be appreciated that the method, system, and device described above are merely exemplary embodiments or examples, and the scope of the present invention is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A computer-implemented method for information processing based on a large language model, comprising:
obtaining query information provided by a user;
determining memory information related to the query information;
determining, based on the query information and the memory information, a tool for processing the query information;
invoking the tool to obtain auxiliary information; and
generating, based on the query information and the auxiliary information, a result of processing the query information.

2. The method according to claim 1, wherein the memory information is obtained based on a dialogue content retrieved from a historical dialogue of the user that matches the query information.

3. The method according to claim 1, wherein the tool comprises a clarification tool, and the invoking of the tool to obtain the auxiliary information comprises:
invoking the clarification tool to initiate an interaction with the user; and
obtaining, through the interaction, interpretation information by the user for the query information.

4. The method according to claim 3, wherein the invoking of the clarification tool to initiate the interaction with the user comprises:
querying the user to guide the user to provide the interpretation information.

5. The method according to claim 1, wherein the tool comprises a retrieval tool, and the invoking of the tool to obtain the auxiliary information comprises:
invoking the retrieval tool to retrieve data resources to obtain reference information for answering the query information.

6. The method according to claim 5, wherein the invoking of the retrieval tool to retrieve the data resources to obtain the reference information for answering the query information comprises:
invoking a first retriever to retrieve business data comprising a plurality of business documents to obtain at least one target business document associated with the query information, wherein the first retriever supports multimodal data retrieval, and the at least one target business document is ranked according to a predetermined ranking strategy.

7. The method according to claim 5, wherein the invoking of the retrieval tool to retrieve the data resources to obtain the reference information for answering the query information comprises:
invoking a second retriever to retrieve news information data comprising a plurality of news information entries to obtain at least one target news information entry associated with the query information.

8. The method according to claim 6, wherein the retrieval is performed based on a transformed retrieval element, and wherein the retrieval element includes a keyword and/or semantics corresponding to the query information.

9. The method according to claim 1, further comprising:
determining, based on the obtained auxiliary information, whether the tool has been correctly invoked; and
in response to determining that the tool has not been correctly invoked, redetermining a new tool for processing the query information.

10. The method according to claim 1, further comprising:
storing, in a predetermined amount of memory for a current dialogue, the memory information related to the query information and the auxiliary information obtained from the invoking of the tool.

11. The method according to claim 1, wherein the method is performed based on a large language model trained by supervised fine-tuning.

12. An electronic device, comprising:
at least one processor; and
a memory communicatively connected to the at least one processor,
wherein the memory stores instructions executable by the at least one processor, and the instructions, when executed by the at least one processor, cause the at least one processor to perform processing comprising:
obtaining query information provided by a user;
determining memory information related to the query information;
determining, based on the query information and the memory information, a tool for processing the query information;
invoking the tool to obtain auxiliary information; and
generating, based on the query information and the auxiliary information, a result of processing the query information.

13. The electronic device according to claim 12, wherein the memory information is obtained based on a dialogue content retrieved from a historical dialogue of the user that matches the query information.

14. The electronic device according to claim 12, wherein the tool comprises a clarification tool, and the invoking of the tool to obtain the auxiliary information comprises:
invoking the clarification tool to initiate an interaction with the user; and
obtaining, through the interaction, interpretation information by the user for the query information.

15. The electronic device according to claim 14, wherein the invoking of the clarification tool to initiate the interaction with the user comprises:
querying the user to guide the user to provide the interpretation information.

16. The electronic device according to claim 12, wherein the tool comprises a retrieval tool, and the invoking of the tool to obtain the auxiliary information comprises:
invoking the retrieval tool to retrieve data resources to obtain reference information for answering the query information.

17. The electronic device according to claim 12, further comprising:
determining, based on the obtained auxiliary information, whether the tool has been correctly invoked; and
in response to determining that the tool has not been correctly invoked, redetermining a new tool for processing the query information.

18. The electronic device according to claim 12, further comprising:
storing, in a predetermined amount of memory for a current dialogue, the memory information related to the query information and the auxiliary information obtained from the invoking of the tool.

19. The electronic device according to claim 12, wherein the processing is performed based on a large language model trained by supervised fine-tuning.

20. A non-transitory computer-readable storage medium storing computer instructions, wherein the computer instructions are used to cause a computer to perform processing comprising:
obtaining query information provided by a user;
determining memory information related to the query information;
determining, based on the query information and the memory information, a tool for processing the query information;
invoking the tool to obtain auxiliary information; and
generating, based on the query information and the auxiliary information, a result of processing the query information.
